(19) United States
(12) Patent Application Publication
(10) Pub. No.: US 2019/0158755 A1
(43) Pub. Date: May 23, 2019

(54) AERIAL VEHICLE AND TARGET OBJECT TRACKING METHOD

(71) Applicant: Chiun Mai Communication Systems, Inc., New Taipei (TW)

(72) Inventors: HSIN-KUAN CHOU, New Taipei (TW); CHENG-YEN LIU, New Taipei (TW); LIN HUNG, New Taipei (TW)

(21) Appl. No.: 16/045,472

(22) Filed: Jul. 25, 2018

(30) Foreign Application Priority Data
Nov. 20, 2017 (CN) 201711161067.3

(51) Int. Cl. H04N 5/232; G06T 7/246; G06K 9/00; G05D 1/12; G05D 1/00; B64C 39/02

(52) U.S. Cl. CPC H04N 5/23299; G06T 7/248; G06K 9/0063; G05D 1/12; G05D 1/0094; G06T 2207/30201; G06K 9/00362; G06K 9/00255; B64C 2201/127; B64C 2201/141; G06T 2207/10032; B64C 39/024

(57) ABSTRACT

A target object tracking method applied in an aerial vehicle which has a tripod head and a camera connected to the tripod head includes steps of obtaining coordinates of a target object from the target object itself and controlling the aerial vehicle to fly towards such coordinates. Images of the target object are obtained from the camera when the aerial vehicle has reached the target object, and further images are obtained at different time points, to determine a moving direction of the target object. The tripod head is rotated according to the determined moving direction, thereby controlling the camera to keep focusing on and tracking the target object.

### FIELD

The subject matter herein generally relates to an aerial vehicle and a target object tracking method.

### BACKGROUND

Unmanned aerial vehicles (UAVs) lack a human pilot aboard. The flight of UAVs can be operated either under remote control by a human operator or autonomously by onboard computers. UAVs are widely used in commercial, scientific, recreational, agricultural, and other applications such as policing, peacekeeping, surveillance, product deliveries, aerial photography, agriculture, smuggling, and drone racing. Although this type of UAV is useful, a UAV capable of automatically tracking target objects is still needed.

Therefore, Improvements in the art are preferred.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a schematic diagram of one embodiment of an aerial vehicle.

FIG. 2 illustrates a block diagram of the aerial vehicle of FIG. 1.

FIG. 3 illustrates a flowchart of one embodiment of a target object tracking method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

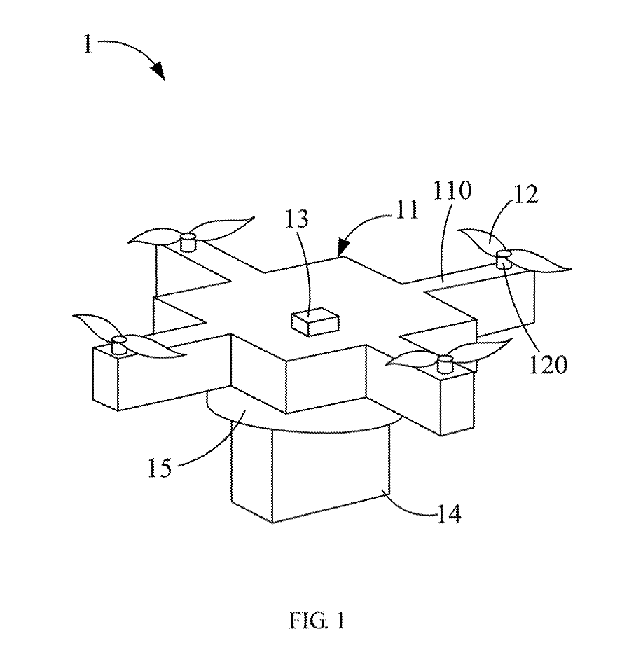

FIG. 1 illustrates one embodiment of an aerial vehicle 1. In the embodiment, the aerial vehicle 1 can be a four-rotor aircraft that comprises a frame body 11, four propellers 12, and four motors 120. The frame body 11 comprises four cantilevers 110 that are positioned at the front, the rear, the left, and the right of the frame body 11. The four motors 120 are connected to end portions of the four cantilevers 110. The four propellers 12 are connected to the four motors 120, and are rotated by the motors 120 to allow the aerial vehicle 1 to take off, land, hover, and to fly forward and backward.

The aerial vehicle 1 further comprises a positioning unit 13, a camera 14, and a tripod head 15. The tripod head 15 is positioned under, and mounted to, the frame body 11. The camera 14 is connected to the tripod head 15, and can capture images of objects within a field of view (FOV) of the camera 14. A target object 2 may be within the FOV of the camera 14. The tripod head 15 can drive the camera 14 to rotate, thereby changing the FOV of the camera 14. The positioning unit 13 is connected to the frame body 11 or the tripod head 15, and can detect coordinates of the aerial vehicle 1 (hereinafter: “original coordinates”).

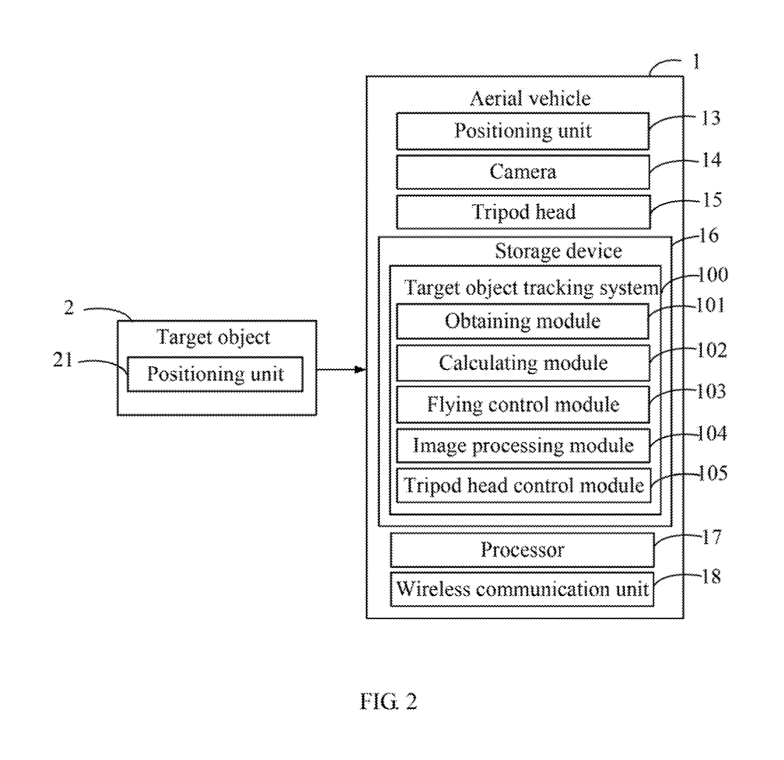

Referring to FIG. 2, the target object 2 also comprises a positioning unit 21 able to detect coordinates of the target object 2 (hereinafter “to-be-tracked coordinates”). In at least one embodiment, each of the positioning unit 13 of the aerial vehicle 1 and the positioning unit 21 of the target object 2 is a GPS positioning unit, that is, the original coordinates and the to-be-tracked coordinates are GPS coordinates. In other embodiments, the positioning unit 13 of the aerial vehicle 1 and the positioning unit 21 of the target object 2 can also make use of other satellite positioning technologies.

The aerial vehicle 1 further comprises a storage device 16 and a processor 17. The storage device 16 stores a target object tracking system 100. The system 100 comprises a number of modules, which are a collection of software instructions executable by the processor 17 to perform the function of the system 100. In at least one embodiment, the storage device 16 can be an internal storage device built inside the aerial vehicle 1. In other embodiments, the storage device 16 can be an external storage device removably connected to the aerial vehicle 1. For example, the storage device 16 can be a smart media card, a secure digital card, or a flash card. The processor 17 can be a central processing unit, a microprocessor, or any other suitable chip having data processing function. In yet other embodiments, the storage device 16 can be located in the cloud or land-based servers (not shown) that are accessible to the aerial vehicle 1 through any type of wireless communication systems.

The system 100 comprises an obtaining module 101, a calculating module 102, a flying control module 103, an image processing module 104, and a tripod head control module 105.

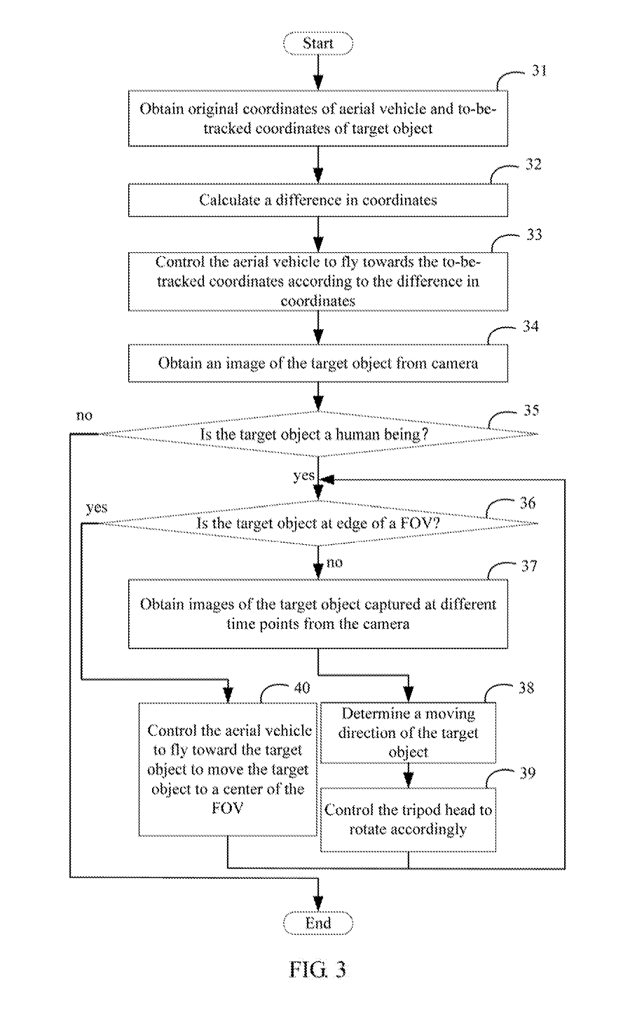

FIG. 3 illustrates an embodiment of a target object tracking method. The method is provided by way of example, as there are a variety of ways to carry out the method. The method described below can be carried out using the configurations illustrated in FIGS. 1-2, for example, and various elements of these figures are referenced in explaining example method. Each block shown in FIG. 3 represents one or more processes, methods, or subroutines, carried out in the example method. Furthermore, the illustrated order of blocks is illustrative only and the order of the blocks can change. Additional blocks can be added or fewer blocks may be utilized or the order of the blocks may be changed, without departing from this disclosure. The example method can begin at block 31.

At block 31, the obtaining module 101 obtains the original coordinates of the aerial vehicle 1 from the positioning unit 13, and obtains the to-be-tracked coordinates of the target object 2.

In at least one embodiment, the positioning unit 21 can be any mobile terminal having a positioning function and a wireless communication function. For example, the positioning unit 21 can be a tablet computer or a smart phone. The positioning unit 21 can send the to-be-tracked coordinates to the aerial vehicle 1. The aerial vehicle 1 further comprises a wireless communication unit 18 for receiving the to-be-tracked coordinates from the positioning unit 21. The wireless communication unit 18 can be a BLUETOOTH® unit or a WIFI unit.

In other embodiments, the aerial vehicle 1 can also comprise a user interface (for example, a touch screen, not shown) for the user to input to the aerial vehicle 1 the to-be-tracked coordinates.

At block 32, the calculating module 102 calculates a difference in coordinates between the aerial vehicle 1 and the target object 2 according to the obtained original coordinates and the obtained to-be-tracked coordinates.

At block 33, the flying control module 103 controls the propellers 12 to rotate according to the calculated difference, causing the aerial vehicle 12 to fly towards the to-be-tracked coordinates of the target object 2.

At block 34, the camera 14 captures an image of the target object 2 at a current time point when the aerial vehicle 1 has reached the to-be-tracked coordinates, and the obtaining module 101 obtains the image.

In at least one embodiment, when the aerial vehicle 1 is flying toward or has reached the to-be-tracked coordinates, the tripod head control module 105 controls the tripod head 15 to rotate until the camera 14 is aimed at the target object 2, thereby allowing the camera 14 to capture the image of the target object 2.

At block 35, the image processing module 104 determines whether the target object 2 is a human being according to the obtained image and facial recognition technology, by comparing the obtained image with baseline image of, for example, humans. If yes, the procedure goes to block 36; otherwise, the procedure ends.

In at least one embodiment, the image processing module 104 detects whether the target object 2 in the obtained image has a human face according to facial recognition technology. When the target object 2 has a human face, the image processing module 104 determines that the target object 2 is a human being. In other embodiments, the target object 2 can also be, but is not limited to, a car or an animal. The image processing module 104 can recognize the nature of the target object 2 in the obtained image according to appearance characteristics pre-stored in the storage device 16.

At block 36, the image processing module 104 determines whether the target object 2 is positioned at an edge of the FOV of the camera 14 according to the obtained image. If yes, the procedure goes to block 40; otherwise, the procedure goes to block 37.

At block 37, the obtaining module 101 obtains at least two images of the target object 2 captured at different time points from the camera 14.

At block 38, the image processing module 104 compares the obtained images to determine any moving direction of the target object 2.

In at least one embodiment, the image processing module 104 detects a human face in each of the obtained images, and further determines a reference position of the detected human face. When the determined reference position in the obtained images moves and a moving distance of the determined reference position is greater than a preset threshold, it indicates that the target object 2 is moving. Then, the image processing module 104 determines the moving direction of the target object 2 according to a moving direction of the determined reference position in the obtained images.

In at least one embodiment, the image processing module 104 can detect eyes in the detected human face, determine a central axis between the detected eyes, and treat the determined central axis as the determined reference position.

At block 39, the tripod head control module 105 controls the tripod head 15 to rotate according to the determined moving direction of the target object 2, thereby adjusting the FOV of the camera 14. Thus, the camera 14 can keep focusing on and tracking the target object 2. Then block 36 is repeated.

When the moving distance of the reference position is less than the preset threshold, it indicates that the target object 2 is not moving, so the aerial vehicle 1 has no need to adjust the FOV of the camera 14.

At block 40, the flying control module 103 controls the propellers 12 to rotate, thereby controlling the aerial vehicle 1 to fly toward the target object 2 to move the target object 2 to a center of the FOV of the camera 14. Then block 36 is repeated.

Therefore, when the aerial vehicle 1 is away (distant) from the target object 2, the aerial vehicle 1 is controlled to fly towards the target object 2. When the aerial vehicle 1 has reached to the target object 2, the tripod head 15 is rotated according to the moving direction of the target object 2, thereby allowing the camera 14 to keep focusing on and tracking the target object 2.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An aerial vehicle comprising:
a tripod head;
a camera connected to the tripod head and configured to capture images of a target object;
a processor; and
a storage device coupled to the processor and storing one or more programs to be executed by the processor, wherein when executed by the processor, the one or more programs cause the processor to:
obtain to-be-tracked coordinates of the target object;
control the aerial vehicle to fly towards the obtained to-be-tracked coordinates;
obtain the images of the target object from the camera when the aerial vehicle has reached the obtained to-be-tracked coordinates;
compare at least two obtained images captured at different time points to determine a moving direction of the target object; and
control the tripod head to rotate according to the determined moving direction, thereby controlling the camera to keep focusing on and tracking the target object.

2. The aerial vehicle of claim 1, further comprising a positioning unit, wherein the positioning unit is configured to detect original coordinates of the aerial vehicle, and causing the processor to control the aerial vehicle to fly towards the obtained to-be-tracked coordinates further comprises:
obtaining the detected original coordinates of the aerial vehicle from the positioning unit;
calculating a difference in coordinates between the aerial vehicle and the target object according to the obtained original coordinates and the obtained to-be-tracked coordinates; and
controlling the aerial vehicle to fly towards the obtained to-be-tracked coordinates according to the calculated difference.

3. The aerial vehicle of claim 1, wherein before comparing at least two obtained images captured at different time points, the one or more programs further cause the processor to:
determine whether the target object is positioned at an edge of a field of view (FOV) of the camera according to the obtained images, wherein the at least two obtained images captured at different time points are compared to each other when the target object is not positioned at the edge of the FOV.

4. The aerial vehicle of claim 3, wherein the one or more programs further cause the processor to:
control the aerial vehicle to fly toward the target object to move the target object to a center of the FOV of the camera when the target object is positioned at the edge of the FOV.

5. The aerial vehicle of claim 3, wherein before determining whether the target object is positioned at an edge of the FOV of the camera, the one or more programs further cause the processor to:
determine whether the target object is a human being according to the obtained images, wherein whether the target object is positioned at the edge of the FOV is determined when the target object is determined to be a human being.

6. The aerial vehicle of claim 5, wherein the one or more programs further cause the processor to detect whether the target object in the obtained images has a human face according to facial recognition technology, and determines that the target object is a human being when the target object has a human face.

7. The aerial vehicle of claim 6, wherein the one or more programs further cause the processor to:
determine a reference position of the detected human face;
determine whether the determined reference position in the obtained images moves and a moving distance of the determined reference position is greater than a preset threshold; and
determine the moving direction of the target object according to a moving direction of the determined reference position in the obtained images when the moving distance of the determined reference position is greater than the preset threshold.

8. A target object tracking method applied in an aerial vehicle, the aerial vehicle comprising a tripod head and a camera connected to the tripod head and configured to capture images of a target object, the target object tracking method comprising:
obtaining to-be-tracked coordinates of the target object;
controlling the aerial vehicle to fly towards the obtained to-be-tracked coordinates;
obtaining the images of the target object from the camera when the aerial vehicle has reached the obtained to-be-tracked coordinates;
comparing at least two obtained images captured at different time points to determine a moving direction of the target object; and
controlling the tripod head to rotate according to the determined moving direction, thereby controlling the camera to keep focusing on and tracking the target object.

9. The target object tracking method of claim 8, further comprising:
obtaining original coordinates of the aerial vehicle from the aerial vehicle;
calculating a difference in coordinates between the aerial vehicle and the target object according to the obtained original coordinates and the obtained to-be-tracked coordinates; and
controlling the aerial vehicle to fly towards the obtained to-be-tracked coordinates according to the calculated difference.

10. The target object tracking method of claim 8, wherein before comparing at least two obtained images captured at different time points, the target object tracking method further comprises:
determining whether the target object is positioned at an edge of a field of view (FOV) of the camera according to the obtained images, wherein the at least two obtained images captured at different time points are compared when the target object is not positioned at the edge of the FOV.

11. The target object tracking method of claim 10, further comprising:
controlling the aerial vehicle to fly toward the target object to move the target object to a center of the FOV of the camera when the target object is positioned at the edge of the FOV.

12. The aerial vehicle of claim 10, wherein before determining whether the target object is positioned at an edge of the FOV of the camera, the target object tracking method further comprises:
determining whether the target object is a human being according to the obtained images, wherein whether the target object is positioned at the edge of the FOV is determined when the target object is determined to be a human being.

13. The target object tracking method of claim 12, further comprising:
determining a reference position of the detected human face;
determining whether the determined reference position in the obtained images moves and a moving distance of the determined reference position is greater than a preset threshold; and
determining the moving direction of the target object according to a moving direction of the determined reference position in the obtained images when the moving distance of the determined reference position is greater than the preset threshold.
